(19) United States
(12) Patent Application Publication
(10) Pub. No.: US 2008/0173518 A1
(43) Pub. Date: Jul. 24, 2008

(54) Method for Operating a Brake System for Motor Vehicles

(75) Inventor: Rainer Klusemann, Frankfurt am Main (DE)

Correspondence Address: CONTINENTAL TEVES, INC., ONE CONTINENTAL DRIVE, AUBURN HILLLS, MI, 48326-1581, US

(73) Assignee: CONTINENTAL TEVES AG &. OHG

(21) Appl. No.: 11/660,656

(22) PCT Filed: Aug. 15, 2005
(86) PCT No.: PCT/EP2005/054007

§ 371 Date: Nov. 5, 2007

(30) Foreign Application Priority Data
Sep. 1, 2004 (DE) 102004042674.0
Jul. 9, 2005 (DE) 102005032152.6

(51) Int. Cl. B60W 10/18; G06F 19/00

(52) U.S. Cl. 192/219.4; 701/70

(57) ABSTRACT

A method for operating an electromechanically operable parking brake for motor vehicles with a driving motor furnished with a mechanical gearbox, uses a clutch pedal travel sensor to sense the position of a clutch pedal of the motor vehicle and a gear information sensor to find out whether the operator has selected a gear of the gearbox.

Since the automated release operation of the parking brake is a safety-critical method, the signals of the clutch pedal travel sensor (18) and the gear information sensor (15) are checked in terms of their plausibility.

### BACKGROUND OF THE INVENTION

The present invention relates to a method for operating an electromechanically operable parking brake for motor vehicles with a driving motor furnished with a mechanical gearbox, being substantially composed of an operating element, an electronic control unit, to which are sent wheel rotational speed values from wheel rotational speed sensors, at least one unit for generating a brake application force, and brake devices on at least one axle being applicable by the unit, with the electronic control unit actuating the unit after detection of a starting maneuver of the motor vehicle in the sense of a release operation of the parking brake, and wherein a clutch pedal travel sensor senses the position of a clutch pedal of the motor vehicle and a gear information sensor finds out whether the operator has selected a gear of the gearbox.

DE 103 24 446 B3 discloses a method for controlling a brake system equipped with an electric parking brake. In the prior art method, a clutch pedal travel sensor is used to determine a first stretch of time from the beginning of the coupling action until a point of time of response of the clutch, which corresponds to the so-called clutch bite-point. The time for performing a release operation of the electric parking brake is selected to be ahead of the point of time of response of the clutch by a second stretch of time. This implies that the parking brake is released in response to the signals of the clutch pedal travel sensor. For safety reasons, it is possible to employ a gear information sensor in addition, the signals of which allow finding out whether the operator has engaged a gear. Safety-critical situations can be encountered after a release operation of the parking brake with the prior art method, in particular when the release operation of the parking brake was performed erroneously due to error signals, what is considered disadvantageous.

In view of the above, an object of the invention is to improve upon a method, which avoids that release operations of the parking brake are performed erroneously and, therefore, offers maximum safety.

### SUMMARY OF THE INVENTION

According to the method, this object is achieved in that the signals of the clutch pedal travel sensor and/or of the gear information sensor are checked in terms of their plausibility. It is arranged that a gear factor is determined for checking purposes, which is defined from a quotient of the rotational speed of the driving motor and the speed of the driven axle.

In a particularly favorable improvement, the signal of the clutch pedal travel sensor, which indicates an application of the clutch pedal, is rated plausible if, simultaneously, the gear factor is not constant and the value of the gear factor is within a valid range. Standstill of the motor vehicle is considered as an invalid range of values for the gear factor, where the gear factor assumes the value ‘infinite’.

In another particularly favorable improvement of the method of the invention, the signal of the gear information sensor indicative of a change of gears is rated plausible if, simultaneously, the gear factor is not constant and a signal of the clutch pedal travel sensor is found out indicating that the clutch pedal was depressed and released again.

As this occurs, automatic release operations of the parking brake are not performed when previously at least one of the signals of the clutch pedal travel sensor and/or the gear information sensor was rated non-plausible.

It is arranged in addition that the information about the plausibility of the signals of the clutch pedal travel sensor and/or the gear information sensor is memorized and will be available after the motor vehicle has been put into service again.

The invention will be explained in detail in the following by way of an embodiment making reference to the accompanying drawings.

### BRIEF DESCRIPTION OF THE DRAWINGS

In the drawings:

FIG. 1 is a schematic circuit diagram of a hydraulic brake system including an electromechanical unit for executing parking brake operations and on which the method of the invention can be implemented;

FIG. 2 shows a flow chart for detecting a starting maneuver and for the subsequent actuation for a release operation of the parking brake;

FIG. 3a shows a graph illustrating a gear factor as a function of time during travel of the motor vehicle, and

FIG. 3b shows a graph illustrating a comparison between the gear factor and the signals of a clutch pedal travel sensor and a gear information sensor.

### DETAILED DESCRIPTION OF THE DRAWINGS

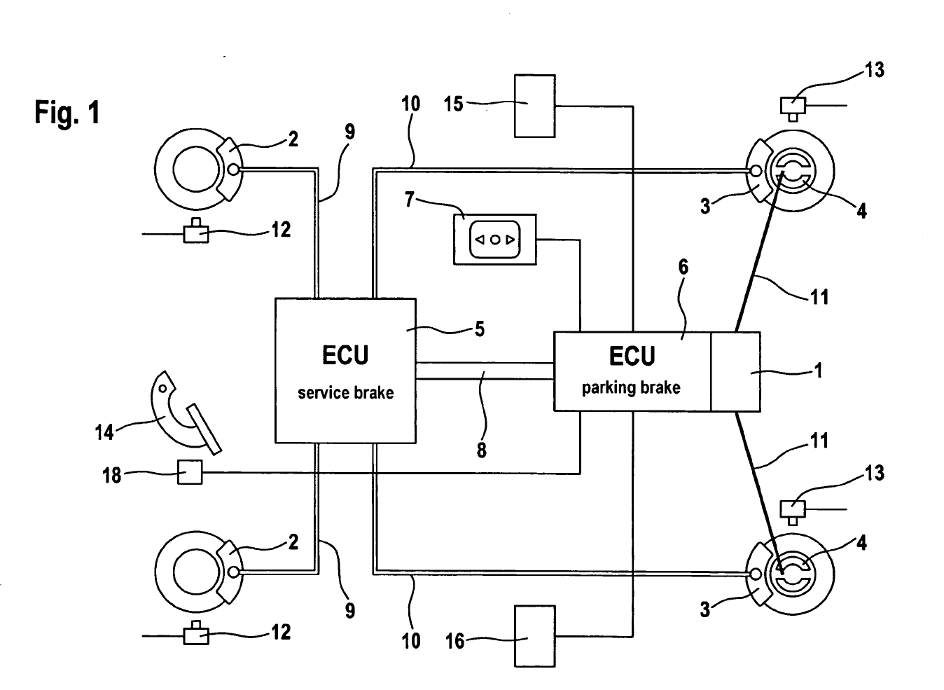

A circuit diagram of a hydraulic brake system is represented in FIG. 1. The hydraulic brake system is equipped with wheel brakes 2 on a first axle, the front axle, which can be pressurized by way of a hydraulic line 9 during service brake operations. To check the desired braking deceleration and realize anti-lock control (ABS) as well as to detect the vehicle speed, wheel rotational speed sensors 12 are associated with the wheels of the front axle whose output signals are sent to an electronic control and regulation unit (ECU) 5. The electronic control and regulation unit 5 is associated with the service brake system. On a second axle, the rear axle, there is also provision of wheel brakes 3 which can be pressurized by way of a second hydraulic line 10 during service brake operations. The rotational speeds of the wheels of the rear axle are determined by using wheel rotational speed sensors 13 and are sent to the above-mentioned electronic control and regulation unit 5. Further, the wheels of the rear axle include an electromechanically operable parking brake in addition to the wheel brakes 3 for service brake operations. The electromechanically operable parking brake comprises two locking brake devices 4, which, in the capacity of drum brakes 4, are designed with each one spreading lock (not shown). The mentioned spreading lock is operable by an electromechanical adjusting unit 1 by means of a cable pull 11, whereupon the drum brakes 4 are applied. A parking brake operation is executed after the operator has actuated an operating element 7. As this occurs, the output signals of the operating element 7 are sent to an electronic control unit (ECU) 6 associated with the electromechanical parking brake, said ECU correspondingly actuating the above-mentioned electromechanical adjusting unit 1. The above-mentioned electronic control unit 6 and the electronic control and regulation unit 5 associated with the service brake system communicate with each other by way of a data line 8 that can be configured as a CAN connection, for example.

FIG. 1 additionally represents a clutch pedal 14 with a clutch pedal travel sensor 18 that determines the clutch pedal travel. Further, the output signals of a gear information sensor 15 and of a sensor for inclination detection 16 determining the incline are sent to the control unit 6 associated with the parking brake. The purpose of the mentioned sensors will be explained in detail in the following.

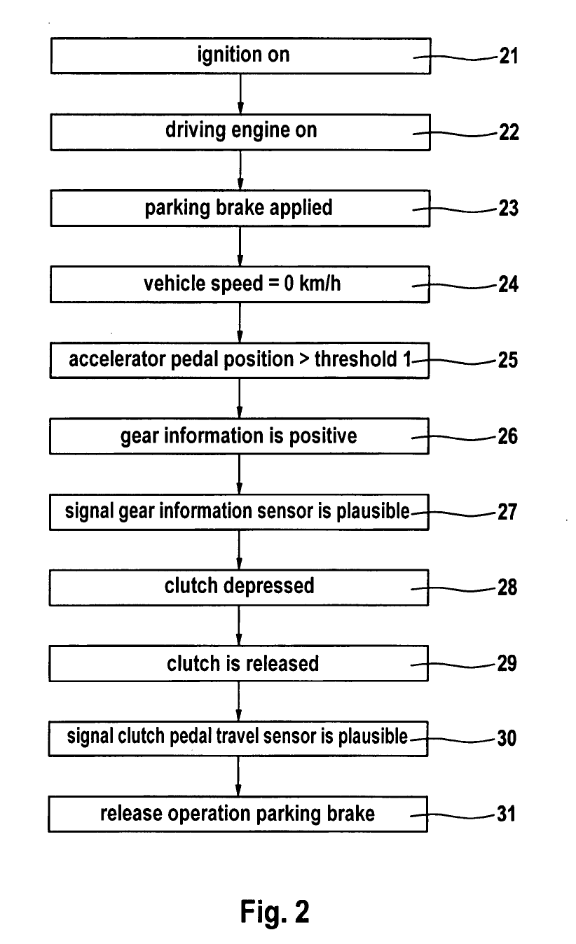

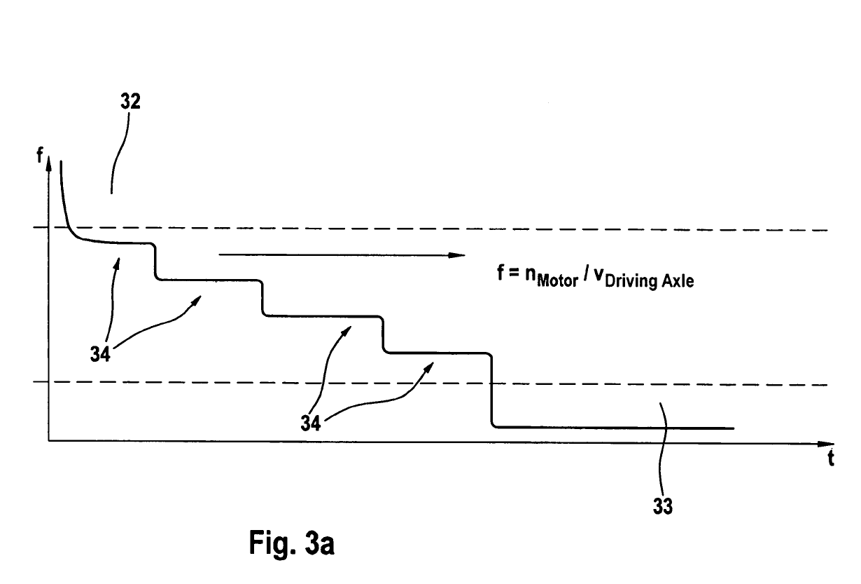

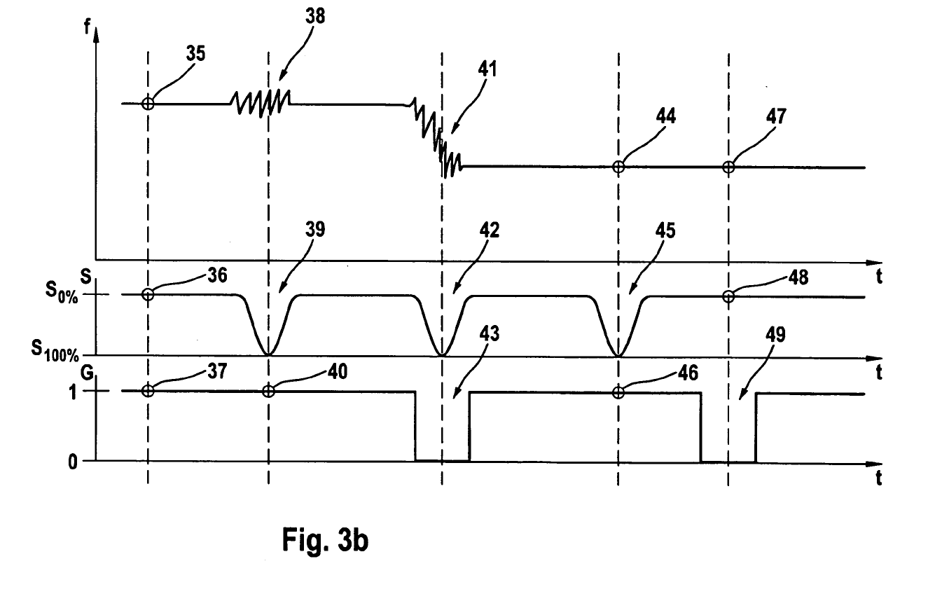

FIG. 2 illustrates a flow chart to detect a starting maneuver of the motor vehicle, and the control unit 6 associated with the parking brake actuates the adjusting unit 1 upon detection of a starting maneuver in the sense of a release operation of the parking brake. To detect a starting maneuver, it is initially checked in process step 21 by way of a signal line (not shown) leading to the ignition lock (not shown) of the motor vehicle whether the ignition of the motor vehicle is activated. In case the ignition is activated, it is assumed under the proviso of the subsequent process steps that the motor vehicle shall be moved. For this purpose, an additional check is made in process step 22 whether the driving motor has adopted the operating mode. It is checked thereafter, whether the parking brake has been applied (process step 23). In the following process step 24 for detection of the starting maneuver, it is found out by means of the wheel rotational speed sensors 12, 13 mentioned with regard to FIG. 1, whether the motor vehicle is at standstill. Subsequently, the position of the accelerator or driving pedal is found out, which latter must be applied to an extent exceeding a predetermined first threshold (process step 25) in order to detect the starting maneuver. It is checked in the following process step 26 by means of the above-mentioned gear information sensor 15, whether the operator has selected a gear. Thereafter, a check is made whether the signal of the gear information sensor is plausible, or whether a plausibility test of the signals of the gear information sensor 15, which has been performed during a previous interval of service, has a positive result (process step 27). The above-mentioned plausibility test is explained more closely in the following with regard to FIG. 3. The evaluation of the signals of the clutch pedal travel sensor 18 allows determining in process step 28 whether the operator has depressed the clutch pedal. If the operator releases the clutch pedal 14 from the depressed position mentioned before, a starting maneuver of the motor vehicle is detected in connection with the conditions referred to hereinabove, and the control unit 6 mentioned with respect to FIG. 1 actuates the adjusting unit 1 in the sense of a release operation of the parking brake (process steps 29, 31). It is, however, still checked prior to the actuation of the adjusting unit 1, whether the signal of the clutch pedal travel sensor 18 is plausible, or whether a previously performed plausibility test of the signals was not negative (process step 30), respectively. As has been mentioned before, the plausibility test of the signals of the clutch pedal travel sensor 18 and of the gear information sensor 15 is dealt with more closely in the following by way of FIG. 3. In case the motor vehicle is placed on a slope having an incline that exceeds a predetermined, third threshold, the drive torque of the driving motor of the motor vehicle is estimated in addition between the process steps 25 and 26 described hereinabove. This estimated drive torque must be higher than a predetermined, second threshold. The gradient of the slope is then found out by way of the sensor for inclination detection 16 mentioned with regard to FIG. 1, which determines the inclination of the motor vehicle.

As the automated release operation of the parking brake, as described by way of FIG. 2, is a safety-critical process, it is provided to check the signals of the clutch pedal travel sensor 18 and of the gear information sensor 15 in terms of their plausibility. This means, it shall be tested whether the signal, which is supplied by one of the sensors, can be ‘correct’. This is done by analyzing signals of additional sensors appearing at the same time. Thus, the plausibility test of the signals is a function test of the associated sensors, which is performed with the aid of signals of other sensors. Alternatively, it would also be possible to install each sensor several times in order to perform a plausibility test using the redundant signals.

To perform the above-mentioned plausibility test, initially, a gear factor f is determined, which is produced by a quotient of the rotational speed of the driving motor n_{Motor} and the speed of the driven axle V_{driving axle}. As this occurs, the speed of the driven axle V_{driving axle} is determined by way of the wheel rotational speed sensors 12, 13 mentioned with respect to FIG. 1, and the rotational speed of the driving motor n_{Motor} is determined by means of a revolution counter (not shown). FIG. 3a shows a graph of the gear factor f as a function of time during the accelerated travel of the motor vehicle. The area 32 above the top dotted line and the area 33 below the bottom dotted line represent so-called invalid areas for determining the gear factor f. The first-mentioned area 32 mirrors e.g. the idle running of the driving motor of the motor vehicle during standstill of the motor vehicle, while the second invalid area 33 represents the gear factor f that develops when the driving motor is uncoupled from the drive train during travel of the motor vehicle and exhibits idling speed.

Between the two invalid areas 32, 33, one can see portions 34 in FIG. 3a, in which the gear factor f is constant. These constant portions correspond in each case to a selected gear. This means, the quotient of the motor rotational speed n_{Motor} and the speed of the driven axle V_{driving axle} is constant within a gear step. The constant value of the gear factor f is, however, different for each gear step and assumes a smaller value when a higher gear is engaged. The higher gear is indicated by the arrow in FIG. 3a. The gear factor f is illustrated in the topmost area in FIG. 3b. In the mid area the actuating condition or the actuating travel S of the clutch pedal 14 is illustrated, and the value S_{0%} describes a non-applied clutch pedal 14, i.e. the operator took his foot from the clutch pedal 14. A fully depressed clutch pedal 14 is described accordingly by the value S_{100%}. The signal G of the gear information sensor 15 is illustrated in the bottom most part of FIG. 3b. When a gear is engaged, this is referred to by the value 1, while the value 0 describes a gear that is not engaged.

The method of the invention will now be explained in more detail by way of FIG. 3b. As has been mentioned before, the gear factor f is constant within a gear step during travel of the motor vehicle, as the area designated by reference numeral 35 shows. Simultaneously, the clutch pedal 14 is not applied by the operator (position 36), and a gear is engaged (position 37). When the operator depresses the clutch pedal 14 during travel of the motor vehicle, the value of the signal S of the clutch pedal travel sensor 18 passes from the initial position S_{0%} to S_{100%} and back to S_{0%} when the operator releases the clutch pedal 14 again (position 39). Since the motor rotational speed n_{Motor} is not constant due to the decoupling of the driving motor, the gear factor f is not constant at the same time (position 38), and the signal of the clutch pedal travel sensor 18 described hereinabove is rated plausible, although the gear information sensor 15 has not detected a change of gears (position 40). Therefore, the process described above concerns a depression of the clutch pedal 14 by the operator during the travel of the motor vehicle, without a change of gears having taken place. This can also be seen because the gear factor f assumes the same value in front of and after the area 38 that is not constant. If a change of gears had taken place, the value for the gear factor f in front of and after the area that is not constant would have to be different, as has been explained by way of FIG. 3a.

Position 43 in FIG. 3b represents such a change of gears. A gear is initially engaged, i.e. the signal G of the gear information sensor 15 assumes the value 1. Subsequently, no gear is selected, what can be seen in the value 0 of the signal G. The value 1 of the signal G reflects a gear, which is selected again thereafter. This sequence of signals of the gear information sensor 15 is rated plausible, because a signal of the clutch pedal travel sensor 18 is simultaneously determined, indicating that the clutch pedal 14 was depressed and released again (position 42). In addition, the gear factor f is isochronously not constant and exhibits a different value in front of the not constant area and thereafter (position 41), what likewise indicates a change in gears, as has been explained before.

The signal of the clutch pedal travel sensor 18 indicating that the clutch pedal 14 was depressed and released again, as is shown in position 45, is rated non-plausible, if simultaneously the gear factor f is absolutely constant (position 44) and additionally the gear information sensor 15 does not detect any change of gears (position 46). In this case, there is the suspicion that the clutch pedal travel sensor 18 is defective. Likewise, the signal of the gear information sensor 15 indicating that a change of gears has taken place (position 49) is rated non-plausible, if the gear factor f is constant isochronously with the signal described above (position 47) and no signal of the clutch pedal travel sensor 18 is determined that the clutch pedal 14 was depressed and released again (position 48). In case the clutch pedal travel sensor 18 or the gear information sensor 15 is defective or their signals are not plausible, respectively, the signals are not used for an automatic release operation of the parking brake in a starting maneuver of the motor vehicle. As the case may be, the automatic release operation of the parking brake is not available to the operator when starting to drive. This fact can be indicated to the operator by means of an optical or acoustic signal.

The fact that the signals of the clutch pedal travel sensor 18 or the gear information sensor 15 are not plausible is stored in a non-volatile memory (not shown), so that this information is available also after new initiation of the motor vehicle. This allows indicating once more to the operator that there is the need to go to a repair shop. Besides, an automatic release operation of the parking brake in response to the erroneous signals of the clutch pedal travel sensor 18 or the gear information sensor 15 is prevented even after a new initiation of the motor vehicle. Further, it is possible to learn that a sensor that has once been rated non-plausible is plausible, if thereafter the signals of the sensor concerned are rated plausible again several times. This allows re-activating the deactivated automatic release operation.

As an alternative of the method of the invention, the clutch pedal travel sensor 18 and the gear information sensor 15 could have a dual design, and their signals could be compared with one another. However, the method of the invention obviates the need for this redundant use of the sensors because the method described is used to check the operability of individual sensors by comparing their signals with signals of additional sensors, the signals of the latter appearing isochronously with the signals of the first-mentioned sensors.

1.-6. (canceled)

7. A method for operating an electromechanically operable parking brake for motor vehicles with a driving motor furnished with a manual-shift gearbox and a pedal-operated clutch, the vehicle having an operating element (7), an electronic control unit (6), to which are sent wheel rotational speed values from rotational wheel speed sensors (12, 13), at least one unit (1) for generating a brake application force, and brake devices (4) on at least one axle being applicable by the unit (1), the method comprising the steps of
engaging the parking brake,
detecting, by means of a gear information sensor, that a gear has been selected,
detecting, by means of a travel sensor, that the clutch pedal (14) is being released,
verifying the information received from the clutch pedal travel sensor (18) and the gear information sensor (15) for plausibility, and,
if the signals are plausible, actuating the unit (1) to release the parking brake.

8. The method as claimed in claim 7,
comprising the step of determining a gear factor (f), which is derived from a quotient of a rotational speed of the driving motor (n_{Motor}) and the rotational wheel speed of the wheels of at least one driven axle (V_{driving axle}).

9. The method as claimed in claim 8,
wherein the information from the clutch pedal travel sensor (18), is verified to be plausible if, simultaneously, the gear factor (f) is not constant and the value of the gear factor (f) is within a valid range.

10. The method as claimed in claim 8,
wherein the information from the gear information sensor (15) is verified to be plausible if, simultaneously, the gear factor (f) is not constant and the information from the clutch pedal travel sensor (18) indicates that the clutch pedal (14) was depressed and released again.

11. The method as claimed in claim 7,
comprising the step of keeping the parking brake in an engaged position if at least one piece of information from the clutch pedal travel sensor (18) or the gear information sensor (15) has been verified not to be plausible.

12. The method as claimed in claim 7,
comprising the step of memorizing the results of the verification in a non-volatile memory and making them available after the motor vehicle has been put out of and back into operation.
